(19) United States
(12) Patent Application Publication
(10) Pub. No.: US 2025/0189241 A1
(43) Pub. Date: Jun. 12, 2025

(54) HEAT EXCHANGE DEVICE AND METHOD FOR CONNECTING THE DEVICE

(71) Applicant: A. Raymond et Cie, Grenoble (FR)

(72) Inventors: Amandine Evelyne Gruny, Village-Neuf (FR); Marie-Hélène Jeanne Isabelle Breniaux, Baldershieim (FR); Laure Marie Drouville, Schiltigheim (FR); Dominique Kroh, Hesingue (FR); Mathias Bois, Champagnier (FR)

(21) Appl. No.: 18/838,835

(22) PCT Filed: Feb. 6, 2023
(86) PCT No.: PCT/EP2023/052826

§ 371 Date: Aug. 15, 2024

(30) Foreign Application Priority Data
Feb. 18, 2022 (FR) FR2201465

(51) Int. Cl. F28F 1/00

(52) U.S. Cl. CPC F28F 1/006

(57) ABSTRACT

A heat exchange, device comprises: a main member provided with a planar assembly face, comprising aluminum, and forming a fluid circulation channel leading into a port arranged on the assembly face; a connection end piece comprising a connection base, the connection base comprising a connection face through which a connection channel opens, the connection base being assembled with the main member by way of an adhesive substance linking an assembly zone of the assembly face that is peripheral to the port to a connection zone of the connection face that is peripheral to the port, the opening and the port being in correspondence with each other, the adhesive substance comprising an adhesive that is either epoxy or polyurethane or acrylic or hybrid, the hybrid adhesive comprising at least two chemical functions chosen from one of epoxy, cyanoacrylate, acrylic and polyurethane.

### CROSS-REFERENCE TO RELATED APPLICATIONS

This application is a national phase entry under 35 U.S.C. § 371 of International Patent Application PCT/EP2023/052826, filed Feb. 6, 2023, designating the United States of America and published as International Patent Publication WO 2023/156235 A1 on Aug. 24, 2023, which claims the benefit under Article 8 of the Patent Cooperation Treaty of French Patent Application Serial No. FR2201465, filed Feb. 18, 2022.

### TECHNICAL FIELD

The disclosure relates to the field of heat exchange devices and, in particular, to heat exchange devices suitable for use in the automotive field. More particularly, the present disclosure relates to a heat exchange device and a method of connecting a heat exchanger plate.

### BACKGROUND

Battery packs in motor vehicles are generally made up of individual cells attached to a chassis and coupled to heat exchange means configured to regulate the temperature (heating or cooling) of the individual cells when they are in operation.

In particular, these heat exchange means may comprise heat exchanger plates providing a fluid circulation channel through which a heat transfer fluid may flow.

The heat exchange means are also connected to an external fluid circuit. In particular, this connection uses connection end pieces. These are usually crimped, soldered or brazed onto the surface of the heat exchanger plates.

In this respect, documents WO2020/254757 A1, WO2020/031221 A1 and FR2832790 A1 disclose a method of connecting a heat exchanger to an external heat exchange circuit by way of a connection end piece. In addition to its specific configuration, this connection means can be welded or bonded to a heat exchanger plate.

However, the solutions proposed in the above-mentioned documents are not satisfactory. Indeed, the methods considered for attaching a connection end piece to a heat exchanger are still complicated to implement, without necessarily fully meeting the requirements of temperature resistance, sealing or mechanical strength.

One of the aims of the present disclosure is, therefore, to offer a heat exchange device with a connection end piece whose attachment complies with requirements in terms of temperature resistance, sealing and mechanical strength.

Another aim of the present disclosure is to propose a method of fluid connection of a pipe, by way of a connection end piece, which is simple to implement and complies with requirements in terms of temperature resistance, sealing and mechanical strength.

### BRIEF SUMMARY

The purposes of the present disclosure are, at least in part, achieved by a heat exchange device that comprises:
a main member with an essentially planar assembly face, comprising aluminum, and forming a fluid circulation channel leading into a port arranged on the assembly face of the main member;
a connection end piece comprising a planar connection base, the connection base comprising a face, referred to as the connection face, through which a connection channel opens, the connection base being assembled with the main member by way of an adhesive substance linking an assembly zone of the assembly face that is peripheral to the port, to a connection zone of the connection face that is peripheral to the opening, the opening and the port being in correspondence with one another, the adhesive substance comprising an adhesive that is either epoxy or polyurethane or acrylic or hybrid, the hybrid adhesive comprising at least two chemical functions chosen from one of epoxy, cyanoacrylate, acrylic and polyurethane.

According to one embodiment, the adhesive substance binds the assembly zone to the connection zone in a mechanical, advantageously chemical, and sealing manner.

According to one embodiment, the end piece comprises an internal shim, which is advantageously annular or oblong, projecting relative to the connection zone and circumscribed by the connection zone, the internal shim being configured to define a space, referred to as the adhesion space, between the connection zone and the assembly zone, wherein the adhesive substance is received.

According to one embodiment, the end piece also comprises a peripheral shim that projects relative to the connection zone and that circumscribes the connection zone so as to define, with the internal shim, the adhesion space.

According to one embodiment, a seal, advantageously an O-ring seal or a lip seal is arranged in a groove provided in the connection face, and interposed between the opening and the internal shim, the internal shim being interposed between the adhesive substance and the groove, and the seal is advantageously in a compressed state within a range of 10% to 35% with respect to the free state volume thereof.

According to one embodiment, the ratio between the surface area of the connection zone and the surface area of the port is adjusted such that the joint between the connection face and the assembly zone has a tensile strength greater than 1 MPa, advantageously greater than 1.6 MPa, even more advantageously greater than 4.3 MPa.

According to one embodiment, the ratio between the surface area of the connection zone and the surface area of the port is adjusted such that the assembly of the connection face with the assembly zone at the end of step d) is sealed when a fluid is circulated at a pressure greater than 1 bar, advantageously greater than 3 bar, even more advantageously greater than 7 bar.

The disclosure also relates to a motor vehicle provided with a battery pack coupled to the heat exchange device according to the present disclosure, for the purpose of regulating the temperature of the battery pack by way of the heat exchange device.

The disclosure also relates to a method for fluid connection of a pipe, by way of a connection end piece, to a main member that is provided with a substantially planar assembly face and comprises aluminum, the main member being provided with a fluid circulation channel leading to a port arranged on the assembly face, the connection end piece comprising a planar base, referred to as the connection base, the connection base comprising a face, referred to as the connection face, through which an opening of a channel, referred to as the connection channel, of the connection end piece extends, the method comprising carrying out the following steps:
a) a first step of preparing the surface of an assembly zone, which is peripheral to the port, the first step comprising a laser treatment and/or an abrasion treatment and/or a chemical treatment, advantageously electro-chemical;
b) a step of depositing an adhesive substance on the assembly zone and/or on a connection zone of the connection face, which connection zone is peripheral to the opening, the adhesive substance comprising an epoxy adhesive or a polyurethane adhesive or an acrylic adhesive or a hybrid adhesive, the hybrid adhesive comprising at least two chemical functions from the epoxy function, the cyanoacrylate function, the acrylic function or the polyurethane function; and
c) a step of assembling the assembly zone and the connection face.

According to one embodiment, the method comprises a step d) of heat treatment intended to crosslink the adhesive substance.

According to one embodiment, step c) is preceded by a step c0), which comprises positioning a seal, in particular, an O-ring seal or a lip seal, in a groove provided in the connection face and interposed between the opening and the connection zone.

According to one embodiment, assembly step c) comprises applying a force, referred to as an assembly force, which is suitable for keeping the seal compressed in a range of 10% to 35% until a predetermined level of crosslinking of the adhesive substance is reached, the predetermined crosslinking being crosslinking that makes it possible to maintain the compression of the seal at a compression between 10% and 35% as soon as the assembly force is no longer applied.

According to one embodiment, the ratio between the surface area of the connection zone and the surface area of the port is adjusted such that the assembly between the connection face and the assembly zone at the end of step d) has a tensile strength greater than 1 MPa, advantageously greater than 1.6 MPa, even more advantageously greater than 4.3 MPa.

According to one embodiment, the ratio between the surface area of the connection zone and the surface area of the port is adjusted such that the assembly of the connection face with the assembly zone at the end of step d) is sealed when a fluid is circulated at a pressure greater than 1 bar, advantageously greater than 3 bar, even more advantageously greater than 7 bar.

According to one embodiment, the first preparation step comprises removing a layer of native aluminum oxide, which is likely to be present in the assembly zone, and adjusting the roughness of the assembly zone to within a roughness range between 1.4 μm and 2.6 μm, advantageously greater than 1.9 μm, the first step involving a LASER method or a mechanical abrasion method.

According to one embodiment, the first preparation step comprises forming an adhesion layer on the assembly zone, and the adhesion layer is advantageously formed according to at least one of the following sub-steps:
anodizing or a chemical conversion treatment of the assembly zone
forming a layer of Ti/Zr on the assembly zone.

According to one embodiment, the method comprises a second step b0) of preparing the surface of the connection face, which is carried out before step b), the second step b0) comprises a plasma treatment and/or a chemical treatment and/or a laser treatment, which is suitable for giving the connection face a surface energy greater than 36 mN/m, advantageously greater than 50 mN/m.

### BRIEF DESCRIPTION OF THE DRAWINGS

Other characteristics and advantages of the disclosure will emerge from the following detailed description of embodiments of the disclosure with reference to the accompanying figures, in which:

FIG. 1 is a schematic representation of a heat exchanger plate implemented in a connection method according to the present disclosure;

FIG. 2 is a schematic representation of a connection end piece that can be used in a connection method according to the present disclosure, the connection end piece shown in a cross-sectional plane passing through axis XX′;

FIG. 3 is a schematic diagram showing the formation of an adhesion layer, in particular, the heat exchanger plate is shown in a sectional plane perpendicular to the assembly face and passing through the port;

FIG. 4 is a schematic representation of the execution of step b) corresponding to the deposition of an adhesive substance on a connection zone of the connection end piece shown in FIG. 2, in particular, the connection end piece is shown in a cross-sectional plane passing through axis XX′;

FIG. 5 is a schematic representation of the execution of step c) corresponding to the assembly of the connection zone with the adhesion zone, in particular, the connection end piece and the heat exchanger plate are shown in a sectional plane passing through axis XX′;

FIG. 6 is a schematic representation of the execution of step c0) on a connection end piece provided with a groove intended to receive a seal, in particular, the connection end piece is shown in a cross-sectional plane passing through axis XX′;

FIG. 7 is a schematic representation of the execution of step c) corresponding to the deposition of an adhesive substance on a connection zone of the connection end piece shown in FIG. 6, in particular, the connection end piece and the heat exchange plate are shown in a cross-sectional plane passing through the XX′ axis.

### DETAILED DESCRIPTION

The present disclosure relates to a heat exchange device. More particularly, the heat exchange device comprises a main member that is provided with a substantially planar assembly face, the member comprising aluminum and forming a fluid circulation channel leading into a port arranged on the assembly face of the main member.

The heat exchange device also comprises a connection end piece comprising a planar connection base.

In particular, the connection base comprises a face, referred to as the connection face, through which a connection channel opens.

In this respect, the connection base is assembled with the main member by way of an adhesive substance linking an assembly zone of the assembly face, peripheral to the port, with a connection zone of the connection face and peripheral to the opening, the opening and port being in correspondence with each other.

According to the present disclosure, the adhesive substance comprises either an epoxy or a polyurethane adhesive or an acrylic adhesive or a hybrid adhesive, the hybrid adhesive comprising at least two chemical functions chosen from one of epoxy, cyanoacrylate, acrylic and polyurethane.

The main member may comprise a heat exchanger plate, a beam or a diffuser. The remainder of the description will be limited to the sole consideration of a heat exchanger plate. However, the person skilled in the art will be able to adapt the principles described below to other elements such as a beam or a diffuser.

The disclosure also relates to a method of fluid connection of a pipe, by way of a connection end piece, with a main member. In particular, the main member is provided with an essentially planar assembly face and comprises aluminum.

The main member is also provided with a fluid circulation channel leading to a port located on the assembly face. The connection end piece comprises a base, referred to as connection base, which may be planar. The connection base comprises a face, referred to as the connection face, through which a channel, referred to as the connection channel, of the connection end piece opens.

The method, according to the present disclosure, comprises the execution of the following steps:
a) a first step of preparing the surface of an assembly zone, which is peripheral to the port, the first step comprising a laser treatment and/or an abrasion treatment and/or a chemical treatment;
b) a step of depositing an adhesive substance on the assembly zone and/or on a connection zone of the connection face, which connection zone is peripheral to the opening, the adhesive substance comprising an epoxy adhesive or a polyurethane adhesive or an acrylic adhesive or a hybrid adhesive, the hybrid adhesive comprising at least two chemical functions from the epoxy function, the cyanoacrylate function, the acrylic function or the polyurethane function; and
c) a step of assembling the assembly zone and the connection face.

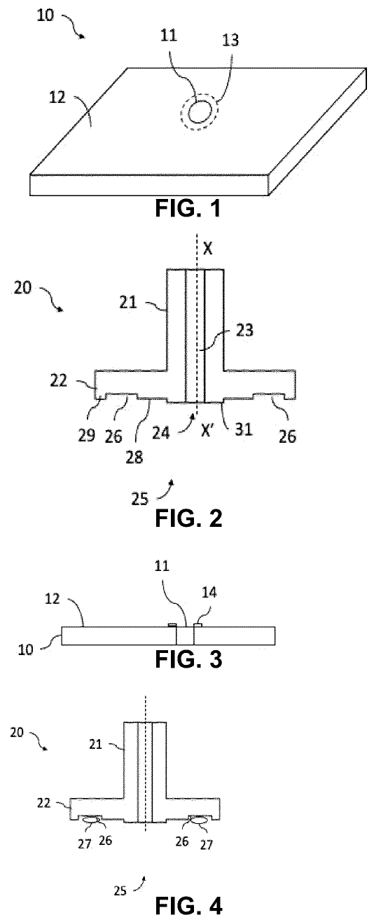

FIG. 1 shows a partial representation of a heat exchanger plate 10. The heat exchanger plate 10 is made of aluminum.

The heat exchanger plate 10 defines a fluid circulation channel opening leading to a port 11 at an assembly face 12 of the heat exchanger plate 10.

In FIG. 2, a schematic representation is shown of a connection end piece 20 intended to be attached to the heat exchanger plate.

In particular, the connection end piece 20 comprises a main body 21, which is generally cylindrical in shape, terminated at one end by a base, referred to as the connection base 22. The connection end piece 20 comprises a channel, referred to as the connection channel 23, which extends in a direction defined by an axis of revolution XX′ of the main body 21, and which leads to an opening 24 arranged on a face, referred to as the connection face 25 of the connection base 22.

The method according to the present disclosure comprises a first step a) of surface preparation of an assembly zone 13 peripheral to the port 11.

The extent and/or characteristics of the assembly zone 13 will be discussed in the following description of embodiments of the present disclosure.

According to the present disclosure, the first surface preparation step a) can be carried out by way of laser treatment and/or abrasion treatment and/or chemical treatment and/or chemical conversion.

It is understood that a surface treatment is used to decontaminate the assembly zone 13 to give it a particular surface energy and/or chemical state and, in particular, compatible with the application of an adhesive substance that will be described in the remainder of the present disclosure.

The native aluminum oxide layer remains uncontrollable. In particular, it may have limited adhesion and consequently form a zone of fragility. Thus, according to a particular embodiment, the first step a) can be performed to remove a layer of native aluminum oxide likely to be present in the assembly zone. It is understood that the removal of the aluminum oxide layer during the execution of the first step is only effective in the assembly zone.

Particularly advantageously, a LASER process can be used to grow a new aluminum oxide layer of controlled thickness and texture when the native aluminum oxide layer is removed. In this respect, the LASER method can include illumination with LASER radiation of wavelength 1 between 900 nm and 1550 nm, for example, equal to 1064 nm, and of fluence between 5 J/cm² 134 J/cm², advantageously between 5 J/cm² and 15 J/cm². The LASER used can be a pulsed LASER or a continuous LASER.

Still according to this embodiment, the first step a) can be carried out to adjust the roughness of the assembly zone within a roughness range Ra of between 1.4 μm and 2.6 μm, advantageously greater than 1.9 μm. This roughness is advantageously measured using a roughness meter with a tip, such as the Marsurf PS 10 roughness meter with a PHT 6-350 probe and a 2 μm tip. The measurement parameters are as follows:
Measuring speed: 1.0 mm/s
Measuring length: 10 mm
Measuring force: 0.75 Mn
Standard followed: DIN EN ISO 4287

According to another embodiment shown in FIG. 3, the first preparation step a) can also include the formation of an adhesion layer 14 on the assembly zone. It is understood that the formation of the adhesion layer can be limited to the assembly zone 13 only.

In a first alternative, the adhesion layer 14 is formed by anodizing, for example, selectively, the assembly zone. Alternatively, the adhesion layer may comprise the formation of a Ti/Zr layer on the assembly zone 13. Also alternatively, the chemical treatment can include a chemical conversion treatment.

The connection method according to the present disclosure also comprises a step b) of depositing an adhesive substance on one and/or other of the assembly zone 13 and a connection zone 26 of the connection face 25 here peripheral to the opening 24.

The adhesive substance comprises either an epoxy adhesive or a polyurethane adhesive or an acrylic adhesive or a hybrid adhesive, the hybrid adhesive comprising at least two chemical functions from among the epoxy function, the cyanoacrylate function, the acrylic function and the polyurethane function.

FIG. 4 shows the deposition of adhesive substance 27 on the connection zone 26.

Particularly advantageously, the connection zone 26 can be delimited internally by an internal shim 28. In particular, the internal shim 28 projects relative to the connection zone 26 and is circumscribed by the connection zone, e.g., the internal shim is annular or oblong in shape.

Still advantageously, the connection zone 26 can also be externally delimited by a peripheral shim 29 projecting relative the connection zone 26 and circumscribing the connection zone 26.

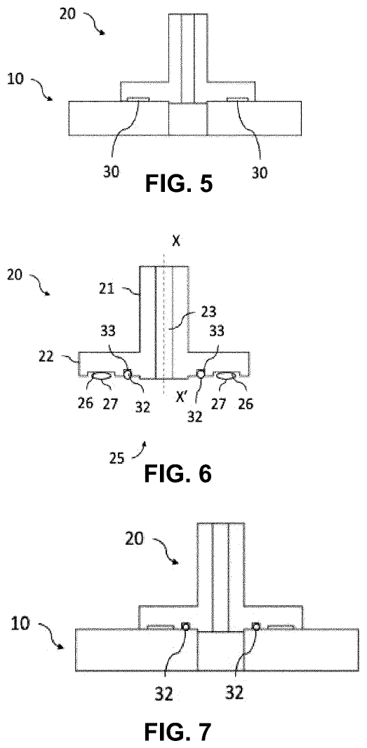

FIG. 5 is a schematic representation of a step c) for assembling the assembly zone and the connection zone.

During this assembly step c), the opening 24 and the port 11 are in correspondence with each other, and the adhesive substance 27 spreads out to fill a space between assembly zone 13 and connection zone 26. The application of the adhesive substance 27 thus enables the assembly zone 13 to be mechanically, advantageously chemically and sealably bonded to the connection zone 26.

“Sealably” means watertight with respect to a coolant and, in particular, with respect to a liquid likely to include glycol.

In this respect, the use of the internal shim 28 and the peripheral shim 29 also makes it possible to define a space, referred to as the adhesion space 30 (FIG. 5), between the connection zone 26 and the assembly zone 13, wherein the adhesive substance 27 is intended to be received. In other words, the internal shim 28 and the peripheral shim 29 make it possible to limit the space wherein the adhesive substance can spread when steps b) and c) are carried out. In particular, the internal shim 28 and the peripheral shim 29 limit any spillage of adhesive substance 27 that may occur during step c).

In addition, the internal shim 28 isolates the opening from the adhesion space and, consequently, from the adhesive substance 27.

In addition, it is understood that the internal shim 28 and the peripheral shim 29 are in contact with the assembly face 12 at the end of step c).

In a particularly advantageous embodiment, it is possible to consider only the internal shim 28 (device without peripheral shim 29). This latter configuration thus provides a flow (and/or creep) path for the adhesive substance other than to the opening 24.

In a further, particularly advantageous embodiment, a discontinuous (open, e.g., slot-shaped) peripheral shim 29 can be considered, thus providing a flow (and/or creep) path for the adhesive substance other than to the opening 24.

In a particularly advantageous embodiment, the adhesive substance can comprise beads, for example, glass beads, whose dimensions (it is understood that average dimensions are concerned) are adapted to impose a predetermined distance between the connection zone 26 and the assembly zone 13. It is understood that if the beads in question were spherical, the dimensions would be equal to the diameter of the beads. This particular embodiment can be considered on its own or in combination with one and/or another of the internal shim and the peripheral shim.

In addition, the connection end piece 20 may comprise guide means for the connection end piece 20, extending from the main body 21 and projecting from the connection face 25. More particularly, the guide means are configured to allow the opening 24 and the port 11 to be matched. The guide means may comprise a shim, called a guide shim 31, peripheral to the opening and intended to be inserted into the hole of port 11. In this respect, the guide shim 31 can be shaped to match the hole of port 11 and/or be frustoconical.

Optionally, after step c), a heat treatment step d) can also be considered to accelerate crosslinking of the adhesive substance. Details of step d) and, in particular, the thermal cycle considered, depend on the adhesive substance in question.

The heat treatment considered for step d) may include a localized heating step. In particular, the heat treatment may comprise induction heating, and more specifically induction heating of the heat exchanger plate 10 made, for example, of aluminum. Induction heating accelerates the cross-linking process of the adhesive substance. In particular, induction heating can be adapted to accelerate cross-linking sufficiently over a period of less than 2 minutes, advantageously less than 1 min 30 seconds. For example, a crosslinking cycle may comprise a heating time followed by a cooling time. In particular, the heating time can be less than 1 min 30 sec, advantageously less than 1 min. This last aspect enables on-line checking of the assembly's seal, for example, sealed at a pressure of 3 bar.

Alternatively or additionally, both the connection end piece 20 and the heat exchanger plate 10 can be preheated prior to step c). In particular, this last aspect helps to compensate for any differences in thermal expansion that may occur during step d). This preheating also helps to maintain precise alignment between the connection end piece 20 and the heat exchanger plate.

Advantageously, the ratio between the surface area of the connection zone and the surface area of the port is adjusted such that the assembly between the connection face and the assembly zone at the end of step d) has a tensile strength greater than 1 MPa, advantageously greater than 1.6 MPa, even more advantageously greater than 4.3 MPa.

Again advantageously, the ratio between the surface area of the connection zone and the surface area of the port is adjusted such that the assembly between the connection face and the assembly zone at the end of step d) is sealed when a fluid is circulated at a pressure greater than 1 bar, advantageously greater than 3 bar, even more advantageously greater than 7 bar, for example, greater than 9 bar, again, for example, greater than 11 bar.

The method according to the present disclosure can also comprise the implementation of a second step b0) for surface preparation of the connection face, carried out prior to step b). The second step b0) comprises a plasma treatment and/or a chemical treatment and/or a laser treatment suitable for giving the connection zone a surface energy greater than 36 mN/m, advantageously greater than 50 mN/m. The latter aspect ensures improved wettability of the connection zone by the adhesive substance.

Surface energy can be measured with a goniometer (e.g., Krüss Mobile Surface Analyzer (MSA) from Krüss). The method employed involves a double drop and, in particular, the measurement of the contact angle of two drops of different liquids (water and diiodomethane), followed by a calculation of the surface energy of the solid.

According to a particularly advantageous embodiment that essentially reproduces the features described above, the method according to the present disclosure can comprise performing a step c0). In particular, step c0) is performed before step c). As shown in FIG. 6, step c0) involves positioning a seal 32 (e.g., an O-ring or lip seal) in a groove 33 provided on the connection face and inserted between the opening and the connection zone. Seal 32 advantageously comprises at least one of the materials chosen from: EPDM, NBR, HNBR, FKM, AEM, FVMQ, Silicone. Advantageously, the second treatment step is not applied to the groove.

FIG. 7 is a schematic representation of a step c) for assembling the assembly zone and the connection zone, once the seal 32 is in place. In particular, the assembly step c) comprises applying a force, referred to as the assembly force, which is suitable for keeping the seal compressed in a range of 10% to 35% until a predetermined level of crosslinking of the adhesive substance is reached, the predetermined crosslinking being crosslinking that makes it possible to maintain the compression of the seal at a compression between 10% and 35% as soon as the assembly force is no longer applied.

The degree of crosslinking of an adhesive depends on its chemistry and thermal history. The person skilled in the art, on the basis of his general knowledge and the chemistry involved, will be able to establish the best possible conditions for achieving a given degree of crosslinking.

It is understood that the device thus obtained may be without the seal 32. The function of the adhesive substance 27 is not only to ensure the assembly of the various elements, but also, depending on its chemical and/or physical properties, to seal the assembly in accordance with the specifications defined in the present description.

The disclosure also relates to a heat exchange device that essentially comprises the features described above.

The disclosure also relates to a motor vehicle provided with a battery pack coupled to the heat exchange device according to the present disclosure, for the purpose of regulating the temperature of the battery pack by way of the heat exchange device.

Of course, the disclosure is not limited to the described embodiments, and variant embodiments may be envisaged without departing from the scope of the invention as defined by the claims.

1. A heat exchange device, comprising:
a main member having a substantially planar assembly face, the main member comprising aluminum and including a fluid circulation channel leading to a port at the substantially planar assembly face of the main member; and
a connection end piece comprising a planar connection base, the planar connection base comprising a connection face through which a connection channel opens in an opening, the planar connection base being assembled to the main member by way of an adhesive substance linking an assembly zone of the substantially planar assembly face, the assembly zone being peripheral to the port, to a connection zone of the connection face, the connection zone is being peripheral to the opening, the opening and the port being in correspondence with one another, the adhesive substance comprising an epoxy adhesive, a polyurethane adhesive, an acrylic adhesive or a hybrid adhesive comprising at least two chemical functions chosen from among epoxy, cyanoacrylate, acrylic or polyurethane, the connection end piece comprising an internal shim, projecting relative to the connection zone and circumscribed by the connection zone, the internal shim being configured to define an adhesion space, between the connection zone and the assembly zone wherein the adhesive substance is received.

2. The heat exchange device of claim 1, wherein the adhesive substance mechanically sealably links the assembly zone to the connection zone.

3. The heat exchange device of claim 1, wherein the connection end piece further comprises a peripheral shim projecting relative to the connection zone and circumscribing the connection zone so as to define, with the internal shim, the adhesion space.

4. The heat exchange device of claim 1, further comprising a seal arranged in a groove in the connection face, and interposed between the opening and the internal shim, the internal shim being interposed between the adhesive substance and the groove.

5. The heat exchange device of claim 1, wherein a ratio between a surface area of the connection zone and a surface area of the port is such that an assembly of the connection face and the assembly zone has a tensile strength greater than 1 MPa.

6. The heat exchange device of claim 1, wherein a ratio between a surface area of the connection zone and a surface area of the port is such that an assembly between the connection face and the assembly zone is sealed when a fluid is circulated at a pressure greater than 1 bar.

7. A motor vehicle provided with a battery pack coupled to a heat exchange device according to claim 1, the heat exchange device configured to regulate a temperature of the battery pack.

8. A method for fluid connection of a pipe, by way of a connection end piece, to a main member having a substantially planar assembly face and comprising aluminum, the main member including a fluid circulation channel leading to a port at the substantially planar assembly face, the connection end piece comprising a planar connection base, the connection base comprising a connection face, through which an opening of a connection channel, of the connection end piece extends, the method comprising the following steps:
a) preparing a surface of an assembly zone peripheral to the port, preparing the surface comprising a laser treatment and/or an abrasion treatment and/or a chemical treatment;
b) depositing an adhesive substance on at least one of the assembly zone or a connection zone of the connection face, the connection zone being peripheral to the opening, the adhesive substance comprising an epoxy or a polyurethane or an acrylic or a hybrid adhesive comprising at least two chemical functions selected from among epoxy, cyanoacrylate, acrylic or polyurethane; and
c) assembling the assembly zone and the connection face;
wherein the connection end piece comprises an internal shim projecting relative to the connection zone and circumscribed by the connection zone, the internal shim defining an adhesion space, between the connection zone and the assembly zone in which the adhesive substance deposited during step b) is received.

9. The method of claim 8, further comprising a step d) comprising heat treating the adhesive substance to cross link molecules of the adhesive substance.

10. The method of claim 8, wherein step c) is preceded by a step c comprising positioning a seal in a groove in the connection face and interposed between the opening and the connection zone.

11. The method of claim 10, wherein step c) comprises applying an assembly force, suitable for keeping the seal compressed in a range of 10% to 35% until a predetermined level of crosslinking of the adhesive substance is reached, the predetermined level of crosslinking being crosslinking sufficient to maintain the compression of the seal at a compression between 10% and 35% as soon as the assembly force is no longer applied.

12. The method of claim 8, wherein a ratio between a surface area of the connection zone and a surface area of the port is adjusted such that assembly between the connection face and the assembly zone at the end of step c) has a tensile strength greater than 1 MPa.

13. The method of claim 8, wherein a ratio between a surface area of the connection zone and a surface area of the port is adjusted such that assembly between the connection face and the assembly zone at the end of step c) is sealed when a fluid is circulated at a pressure greater than 1 bar.

14. The method of claim 8, wherein step a) comprises removing a layer of native aluminum oxide present in the assembly zone and adjusting roughness of the assembly zone to within a roughness range between 1.4 μm and 2.6 μm, and wherein step a) involves a LASER method or a mechanical abrasion method.

15. The method of claim 8, wherein step a) comprises forming an adhesion layer on the assembly zone, the adhesion layer being formed according to at least one of the following sub-steps:
anodizing or a chemical conversion treatment of the assembly zone; and/or
forming a layer of Ti/Zr on the assembly zone.

16. The method of claim 8, further comprising a second step b0) of preparing a surface of the connection face, which is carried out before step b), the second step b0) comprising a plasma treatment and/or a chemical treatment and/or a laser treatment suitable for giving the connection face a surface energy greater than 36 mN/m.

17. The heat exchange device of claim 2, wherein the adhesive substance also chemically sealably links the assembly zone to the connection zone.

18. The heat exchange device of claim 4, wherein the seal comprises an O-ring seal or a lip seal, the seal being made of EPDM or silicon.

19. The heat exchange device of claim 4, wherein the seal is in a compressed state within a range of 10% to 35% with respect to a free state volume of the seal.

20. The heat exchange device of claim 5, wherein the ratio between the surface area of the connection zone and the surface area of the port is such that the assembly of the connection face and the assembly zone has a tensile strength greater than 4.3 MPa.
